(19) United States
(12) Patent Application Publication
(10) Pub. No.: US 2003/0018917 A1
(43) Pub. Date: Jan. 23, 2003

(54) Method and apparatus for delivering digital media using packetized encryption data

(76) Inventor: Matthew W. Brown SR., Charlotte, NC (US)

Correspondence Address: Micah Goldsmith, 1135 Menlo Drive, Altadena, CA, 91001, US

(21) Appl. No.: 09/910,687

(22) Filed: Jul. 23, 2001

(51) Int. Cl. H04L 9/00

(52) U.S. Cl. 713/201

(57) ABSTRACT

The present invention provides a method and apparatus for delivering digital media using packetized encryption data. According to the present invention, a client computing device initiates a session with the server via a computer network and requests a digital media stream. In response, the server authenticates the users and delivers the digital media stream using one or more security processes. In one embodiment, the security process is encryption which is used during the transmission of the digital media from the server to the client. The encryption ensures that the digital stream is protected from copying. In one embodiment, a secure delivery protocol is used wherein a configurable key exchange between the client and the server occurs simultaneous with the delivery of the actual data. As part of the key exchange, encapsulated packets maybe sent between the client and the server, wherein the encapsulated packet contains a header and a payload. The payload contains fragments of the actual digital media that is being used (i.e., movie, song, television program, etc.) The header contains the configurable and rolling encryption key that is sent to the client.

Portions of the disclosure of this patent document contain material that is subject to copyright protection. The copyright owner has no objection to the facsimile reproduction by anyone of the patent document or the patent disclosure as it appears in the Patent and Trade mark Office file or records, but otherwise reserves all copyright rights whatsoever.

### BACKGROUND OF THE INVENTION

1. Field of the Invention

The present invention relates to computer networking, and in particular to a secure method for delivering digital media across a computer network by using packetized encryption data.

2. Background Art

The delivery of digital media in the form of video, audio, and other data streams has become an important part of the Internet. It allows users to view movies and listen to music on computers, which gives them an enjoyable entertainment experience, but also harnesses the power of the computer which enhances the experience.

The manner in which digital media is currently transported across networks is problematic. In particular, the digital media (i.e., movie, song, voice over IP, or other secure data) that an end user downloads typically does not provide an effective mechanism with which to protect the copyright owner.

Copyright

Media that is in high demand, such as a popular movie or a song, is typically owned by a person or business. The rightful owner has a legal right outlined in the copyright laws to control the distribution of the copyrighted material or to be compensated when the media is published, copied, or otherwise listened to or enjoyed.

In the case of cable television, it is common for a cable box to be configured to receive a signal where the signal is encrypted and scrambled by the cable provider and decrypted and unscrambled at the cable box. This protects copyright owners because it ensures that the people who receive the signal are those who are intended to receive the signal (i.e., those who have paid for it). In the case of the Internet, where a multi-tier computer architecture is used, such protection is more difficult. Below is an overview of a multi-tier computer architecture.

Multi-Tier Computer Architecture

The Internet typically uses a computer architecture that is multi-tiered. FIG. 1 provides an example of a three-tier architecture. Client tier 100 typically consists of a computer system that provides a graphic user interface (GUI) generated by a client 110, such as a browser or other user interface application. Conventional browsers include Internet Explorer and Netscape Navigator, among others. Client 110 generates a display from, for example, a specification of GUI elements (e.g., a file containing input, form, and text elements defined using the Hypertext Markup Language (HTML)) and/or from an applet (i.e., a program such as a program written using the Java programming language, or other platform independent programming language, that runs when it is loaded by the browser).

Further application functionality is provided by application logic managed by application server 120 in application tier 130. The apportionment of application functionality between client tier 100 and application tier 130 is dependent upon whether the computer environment is a “thin client” or “thick client” topology.

In a thin client topology, the end user's computing device is limited in power. These devices include, for instance, set-top boxes, personal data assistants (PDA), or web-enabled cellular phones. In this topology, the client tier is used primarily to display output and obtain input, while computing takes place in the application tier.

A thick client topology, on the other hand, uses a more conventional general purpose computer having dedicated processing, memory, and data storage abilities. Database tier 140 contains the data that is accessed by the application logic in application tier 130. Database server 150 manages the data, its structure and the operations that can be performed on the data and/or its structure.

Application server 120 can include applications such as a corporation's scheduling, accounting, personnel and payroll applications, for example. Application server 120 manages requests for the applications stored there. Application server 120 also manages the storage and dissemination of production versions of application logic (i.e., the versions that are current). Database server 140 manages the database(s) that manage data for applications. Database server 140 responds to requests to access the scheduling, accounting, personnel and payroll applications' data, for example.

Connection 160 is used to transmit enterprise data between client tier 100 and application tier 150, and may also be used to transfer the enterprise application logic to client tier 100. The client tier can communicate with the application tier via, for example, a Remote Method Invocator (RMI) application programming interface (API) available from Sun Microsystems™. The RMI API provides the ability to invoke methods, or software modules, that reside on another computer system. Parameters are packaged and unpackaged for transmittal to and from the client tier. Connection 170 between application server 120 and database server 150 represents the transmission of requests for data and the responses to such requests from applications that reside in application server 120.

Elements of the client tier, application tier and database tier (e.g., client 110, application server 120, and database server 150) may execute within a single computer. However, in a typical system, elements of the client tier, application tier and database tier may execute within separate computers interconnected over a network such as a LAN (local area network) or WAN (wide area network).

Digital Media Delivery

As multi-tier computer architectures like the Internet have developed, a need has emerged to effectively deliver digital media to its users. In particular, a user of the Internet typically uses a web browser or other GUI which displays the data output of one or more servers connected to the Internet. One form of such data output may be in the form of digital media. Digital media is provided, for instance, by converting an analog form of media, such as a movie, television show, or song, into a digital form. Then, the digital form is compressed into a particular file format and delivered by a communications path between the server and the end user's computing device where the end user's device is configured to use files in the format received.

Conventional file formats for the delivery of digital media include, for instance the MPEG and AVI formats. These formats attempt to compress data in a bandwidth limited environment. For the most part, they succeed, but data transfer on the Internet is still slow. It is desirable to apply security to the data as well, but it is difficult to associate additional security processes, such as scrambling and descrambling, to the delivery of digital media across a multi tiered computer architecture. This is especially true when these additional processes cause further bottelnecks to the limited bandwidth already available and may cause the user to have an unreasonably slow entertainment experience.

### SUMMARY OF THE INVENTION

The present invention provides a method and apparatus for the delivery of digital media using destination specific, packetized encryption data. Digital media includes video streams, audio streams, voice over IP, and other forms of secure data. According to the present invention, a client computing device initiates a session with the server via a computer network. In one embodiment, the session is initiated using the Internet, where the client sends a request to the server for a digital media stream. The server authenticates the client and delivers the digital media stream using one or more security processes, if authenticated.

In one embodiment, the security process is encryption (scrambling) which is used during the transmission of the digital media from the server to the client and decryption (descrambling) on the client. The encryption ensures that the digital stream is protected from unauthorized copying. In one embodiment, a secure delivery protocol is used wherein a configurable key exchange between the client and the server occurs simultaneous to the delivery of the actual data.

As part of the key exchange, encapsulated packets are exchanged between the client and the server, wherein the encapsulated packets contain a header and a payload. The payload contains fragments of the actual digital media that is being used (i.e., movie, song, television program, etc.) The header contains the configurable and rolling encryption key that is sent to the client.

In another embodiment, the digital media is indexed and catalogued in a database with one or more other digital files on a server. When a user accesses the Internet and uses the database to locate an appropriate digital file for downloading, software coupled to their web browser (a plug-in) initiates the creation of a dedicated connection using a unique id for the client, such as a MAC address. Once the dedicated connection is established, the server begins delivering packets to the client. The packets contain fragments of the media concatenated with the rolling encryption data. The plug in used by the present invention may be enhanced to perform the functionality of a traditional VCR or CD player. The client computing device may be a digital television, a set-top box, a personal data assistant, a general purpose computer, or any other digital device capable of using the Internet.

### BRIEF DESCRIPTION OF THE DRAWINGS

These and other features, aspects and advantages of the present invention will become better understood with regard to the following description, appended claims and accompanying drawings where:

FIG. 1 is an overview of the multi-tier computer architecture.

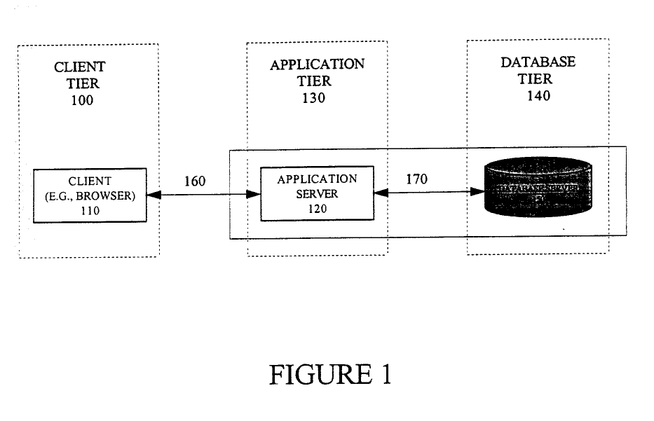

FIG. 2A is a flowchart showing the secure delivery of digital media according to an embodiment of the present invention.

FIG. 2B is a block diagram showing an architecture for the secure delivery of digital media according to one embodiment of the present invention.

FIG. 3A is a block diagram of a typical cryptographic system.

FIG. 3B is an example of a data encryption standard system.

FIG. 4 is a block diagram showing an architecture for the secure delivery of digital media according to one embodiment of the present invention.

FIG. 5 is a block diagram showing an architecture for the secure delivery of digital media according to one embodiment of the present invention.

FIG. 6 is a block diagram showing an architecture for the secure delivery of digital media according to one embodiment of the present invention.

FIG. 7 is a flowchart showing a security process according to an embodiment of the present invention.

FIG. 8 is a flowchart showing an IP multi-cast according to an embodiment of the present invention.

FIG. 9 is a flowchart showing a dedicated connection according to an embodiment of the present invention.

FIG. 10A shows a packet format according to one embodiment of the present invention.

FIG. 10B shows a packet format according to another embodiment of the present invention.

FIG. 11 shows an embodiment of a computer execution environment.

FIG. 12 is a flowchart showing the use of variable length keys according to an embodiment of the present invention.

### DETAILED DESCRIPTION OF THE INVENTION

The invention is a method and apparatus for delivering digital media using packetized encryption data. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

Secure Delivery

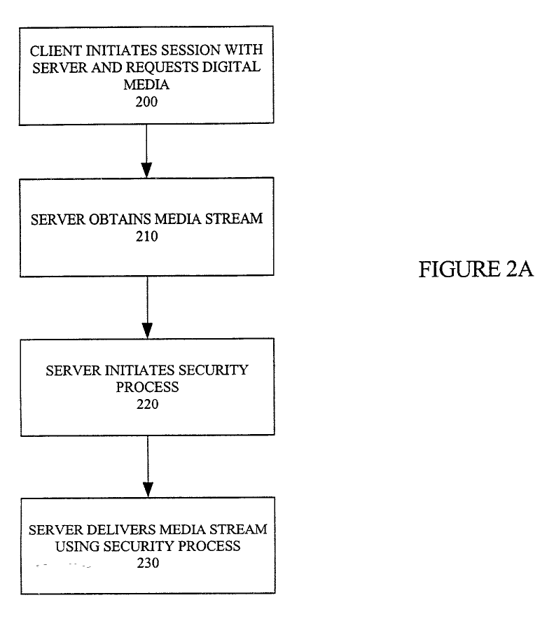

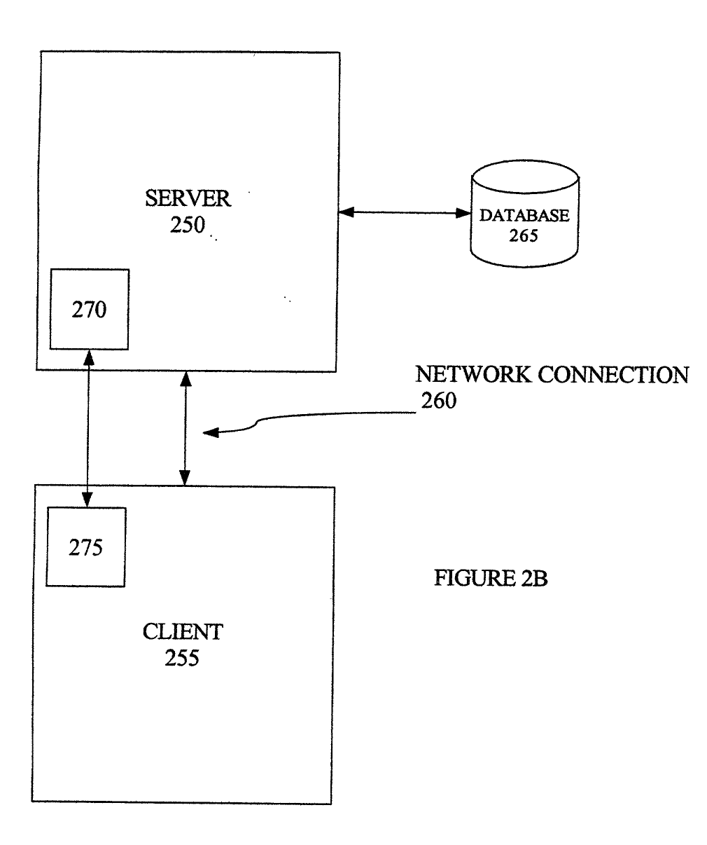

According to the present invention, a client computing device initiates a session with the server via a computer network. In one embodiment, the session is initiated using the Internet, where the client sends a request to the server for a digital media stream. The server responds to the client by delivering the digital media in packets along with the security data, if the user is properly authenticated. This embodiment of the present invention is shown in FIG. 2A.

At box 200, a client computing device initiates a session with a server and requests a digital media stream. At box 210, the server obtains the media stream if the user is authenticated, for instance by accessing a database where the media stream is stored. At box 220, the server initiates a security process and at box 230, the server delivers the media stream securely using the security process.

FIG. 2B is a block diagram showing an architecture that is used by the present invention. Server 250 is connected to client 255 via network connection 260. Network connection 260 may be a phone line, a cable line, a wireless link, or other connection capable of creating a computer network known to those skilled in the art. Server 250 accesses database 265 to obtain the digital media for delivery. As the media is delivered, security processes 270 and 275 are activated to ensure that the media is securely delivered and cannot be copied by unauthorized users, and if copied, is not viewable or useable in any way due to the encryption.

In one embodiment, an encryption key that can be used by the client to decrypt the data is embedded in the packet and may be encrypted as well in transit and decrypted on the client. Rolling code encryption that follows the data encryption standard (DES) is used by another embodiment of the present invention. In this case, security processes 270 and 275 undergo a configurable rolling key exchange. The keys (used to descramble the data) are transmitted along with the digital media, for instance concatenated to the digital media in packets sent between the server and the client. An overview of some possible forms of encryption is now provided.

Cryptographic Systems

Blocks 270 and 275 may use for instance, a cryptographic system. A cryptographic system is a system for sending a message from a sender to a receiver over a medium so that the message is “secure”, that is, so that only the intended receiver can recover the message. A cryptographic system converts a message, referred to as “plaintext” into an encrypted format, known as “ciphertext.” The encryption is accomplished by manipulating or transforming the message using a “cipher key” or keys. The receiver “decrypts” the message, that is, converts it from ciphertext to plaintext, by reversing the manipulation or transformation process using the cipher key or keys. So long as only the sender and receiver have knowledge of the cipher key, such an encrypted transmission is secure.

A “classical” cryptosystem is a cryptosystem in which the enciphering information can be used to determine the deciphering information. To provide security, a classical cryptosystem requires that the enciphering key be kept secret and provided to users of the system over secure channels. Secure channels, such as secret couriers, secure telephone transmission lines, or the like, are often impractical and expensive. A system that eliminates the difficulties of exchanging a secure enciphering key is known as “public key encryption.”By definition, a public key cryptosystem has the property that someone who knows only how to encipher a message cannot use the enciphering key to find the deciphering key without a prohibitively lengthy computation.

An enciphering function is chosen so that once an enciphering key is known, the enciphering function is relatively easy to compute. However, the inverse of the encrypting transformation function is difficult, or computationally infeasible, to compute. Such a function is referred to as a “one way function” or as a “trap door function.” In a public key cryptosystem, certain information relating to the keys is public. This information can be, and often is, published or transmitted in a non-secure manner. Also, certain information relating to the keys is private. This information may be distributed over a secure channel to protect its privacy, (or may be created by a local user to ensure privacy).

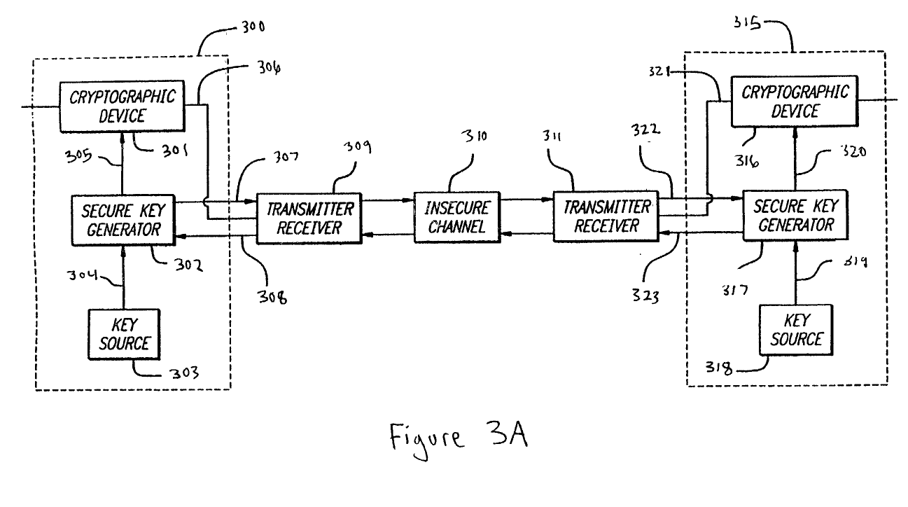

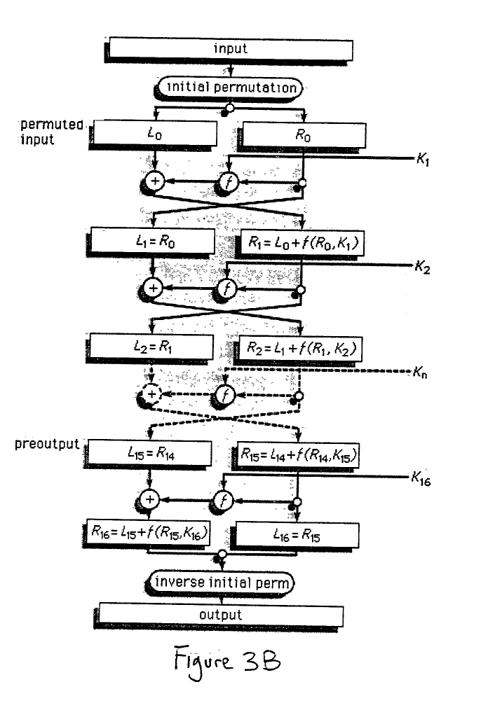

block diagram of a typical public key cryptographic system is illustrated in FIG. 3A. A sender represented by the blocks within dashed line (300) sends a plaintext message, Ptxt, to a receiver, represented by the blocks within dashed line (315). The plaintext message is encrypted into a ciphertext message, C, transmitted over some transmission medium and decoded by the receiver (315) to recreate the plaintext message Ptxt. The sender (300) includes a cryptographic device (301), a secure key generator (302) and a key source (303). The key source (303) is connected to the secure key generator (302) through line (304). The secure key generator (302) is coupled to the cryptographic device (301) through line (305). The cryptographic device provides a ciphertext output, C, on line (306).

The secure key generator (302) provides a key output on line (307). This output is provided, along with the ciphertext message (306), to transmitter receiver (309). The transmitter receiver (309) may be, for example, a computer transmitting device such as a modem or it may be a device for transmitting radio frequency transmission signals. The transmitter receiver (309) outputs the secure key and the ciphertext message on an insecure channel (310) to the receiver's transmitter receiver (311).

The receiver (315) also includes a cryptographic device (316), a secure key generator (317) and a key source (318). The key source (318) is coupled to the secure key generator (317) on line (319). The secure key generator (317) is coupled to the cryptographic device (316) on line (320). The cryptographic device (316) is coupled to the transmitter receiver (311) through line (321). The secure key generator (317) is coupled to the transmitter receiver (311) on lines (322) and (323).

In operation, the sender (300) has a plaintext message, Ptxt, to send to the receiver (315). Both the sender (300) and the receiver (315) have cryptographic devices (301) and (316), respectively, that use the same encryption scheme. There are a number of suitable cryptosystems that can be implemented in the cryptographic devices. For example, they may implement the Data Encryption Standard (DES) or some other suitable encryption scheme. Sender and receiver also have secure key generators (302) and (317), respectively. These secure key generators implement anyone of several well known public key exchange schemes. These schemes, which will be described in detail below, include the Diffie-Hellman scheme, the RSA scheme, the Massey-Omura scheme, or the rolling code scheme.

The sender (300) uses key source (303), which may be a random number generator, to generate a private key. The private key is provided to the secure key generator (302) and is used to generate an encryption key, eK. The encryption key, eK, is transmitted on lines (305) to the cryptographic device and is used to encrypt the plaintext message, Ptxt, to generate a ciphertext message, C, provided on line (306) to the transmitter receiver (309). The secure key generator (302) also transmits the information used to convert to the secure key from key source (303) to the encryption key, eK.

This information can be transmitted over an insecure channel, because it is impractical to recreate the encryption key from this information without knowing the private key. The receiver (315) uses key source (318) to generate a private and secure key ( 319). This private key (319) is used in the secure key generator (317) along with the key generating information provided by the sender (300) to generate a deciphering key, DK. This deciphering key, DK, is provided on line (320) to the cryptographic device (316) where it is used to decrypt the ciphertext message and reproduce the original plaintext message.

The Data Encryption Standard (DES)

The DES is a product block cipher in which 16 iterations, or rounds, of the substitution and transposition (permutation) process are cascaded. The block size, for instance, might be 64 bits, so that a 64-bit block of data (plaintext) can be encrypted into a 64-bit cipher at any one time. (A 64-bit block cipher can be decrypted by the DES as well.) The key, which controls the transformation, also consists of 64 bits. Only 56 of these, however, are at the user's disposal; the remaining eight bits are employed for checking parity (the state of being odd or even used as a basis for detecting errors in binary-coded data).

FIG. 3B is a functional schematic of the sequence of events that occurs in the DES encryption (or decryption) transformation. Subsets of the key bits are designated K1, K2, etc., with the subscript indicating the number of the round. The cipher function (substitution and transposition) that is used with the key bits in each round is labeled f. At each intermediate stage of the transformation process, the cipher output from the preceding stage is partitioned into the 32 leftmost bits, Li, and the 32 rightmost bits, Ri. Ri is transposed to become the left-hand part of the next higher intermediate cipher, Li+1. The right-hand half of the next cipher, Ri+1, however, is a complex function of the key and of the entire preceding intermediate cipher.

The essential feature to the security of the DES is that f involves a very special nonlinear substitution (i.e., f(A)+f(B)=f(A+B)) specified by the Bureau of Standards in tabulated functions known as S boxes. This operation results in a 32-bit number, which is logically added to Ri to produce the left-hand half of the new intermediate cipher. This process is repeated, 16 times in all. To decrypt a cipher, the process is carried out in reverse order, with the 16th round being first.

Secure Delivery Architecture

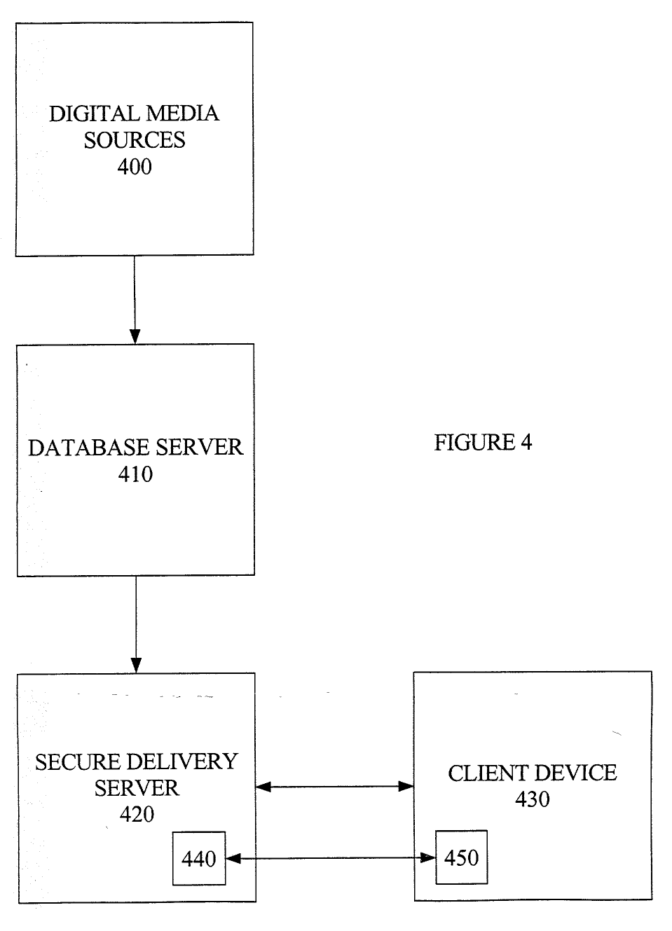

Given the backdrop of some possible forms of encryption, FIG. 4 shows another architecture used by an embodiment of the present invention that implements these encryption forms. Digital media sources 400 might include a satellite dish, radio tower, cable source, or video from a live event. The digital media sources are provided to a database server 410, which is used to catalogue the data. Database server 410 might also be used to control access to the content.

Database server 410 provides the digital media to secure delivery server 420. The secure delivery server 420 is used to receive the media and to perform a security function with a client device 430. Client devices include televisions, stereos, general purpose computers, set top boxes, or any other device capable of handling digital data. Server security block 440 on the secure delivery server is coupled to client security block 450 on the client device 430. Blocks 440 and 450 continually exchange keys using a rolling encryption code. This serves to scramble the digital signal as it traverses the Internet, thereby protecting it from copying.

Using a rolling encryption code, server security block 440 initially generates a 128 bit word, a variable length hash, and a key. This data is sent to client security block 450 where it is decrypted and an encrypted response is returned to the server at a predefined and adjustable interval (e.g., 45 milliseconds). At each interval, the encryption key rolls according to a configurable algorithm. For instance, the actual value that represents the key can be incremented in a binary fashion. Then, another key exchange occurs, which results in a data transmission to the client that is encrypted and scrambled when it leaves the server and decrypted and unscrambled when it reaches the client.

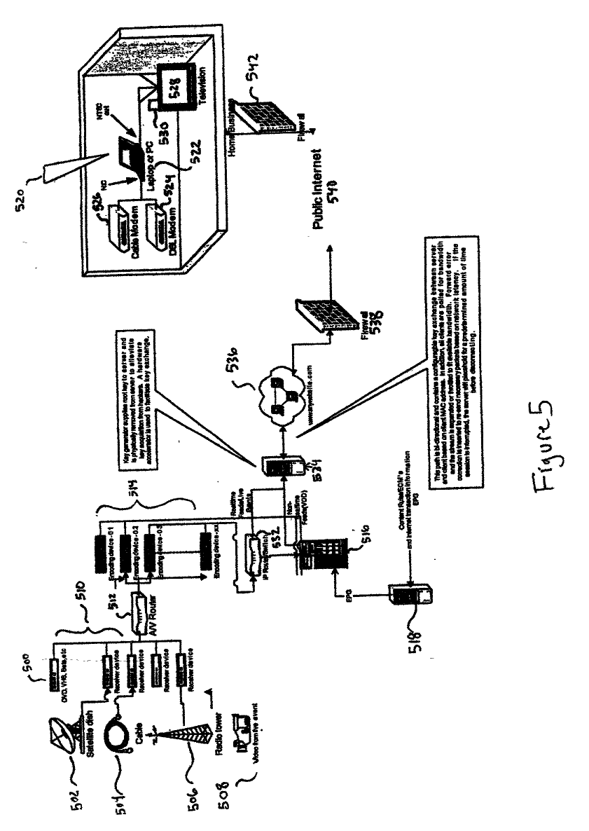

FIG. 5 shows an architecture according to another embodiment of the present invention. Digital media sources include DVD, VHS, or Beta source 500, a satellite dish 502, a cable line 504, a radio tower 506, or video from a live event 508, for instance. The media sources are provided to receiver devices 510 which pass the media to router 512 and through encoding device 514. Eventually, the media reaches a storage array 516, which might have a fiber channel interface. A content management server 518 might be used to completely record all details about the media, including content restriction, revenue sharing, and access rights.

In operation, client tier 520, obtains software via a website download and initiates a registration process which obtains a user name and password, as well as a unique id for the device, such as a MAC address. Client tier 520 includes a computer 522, such as a laptop or PC connected with a DSL modem 524 or a cable modem 526 or a television 528 or set top box 530. Once the client tier requests the digital media, an authentication process occurs, which if successful results in content management server 518 causing data in database server 510 to pass through switch 532 to secure delivery server 534.

The client device has a GUI, which might be a browser such as Internet Explorer or Netscape Navigator. The GUI includes a plug-in component which is used for the encryption operations and the descrambling of the digital media. In the case of an IP multicast, multiple clients might be receiving the same digital data and undergo similar security processes. In various embodiments of the present invention, the plug in may be enhanced to perform the functionality of a traditional VCR or CD player. In other embodiment, the client computing device is a digital television, a set-top box, a personal data assistant, a web-enabled cellular phone or a general purpose computer.

Secure delivery server 534 receives the digital media and encapsulates it into a packet which also contains an encryption code. The packet is sent via a website 536, through a firewall 538 if necessary, through the public Internet 540, through another firewall 542, if necessary and to the client tier 520. The encryption code includes, for instance, a root key that is generated from a key generator on the secure delivery server 534. In one embodiment, the entire packet is 4096 bits in length and contains a header and a payload. The payload contains digital information, for instance in MPEG2 or MPEG4 formats. The header contains the security data, including the rolling encryption keys used to descramble the data.

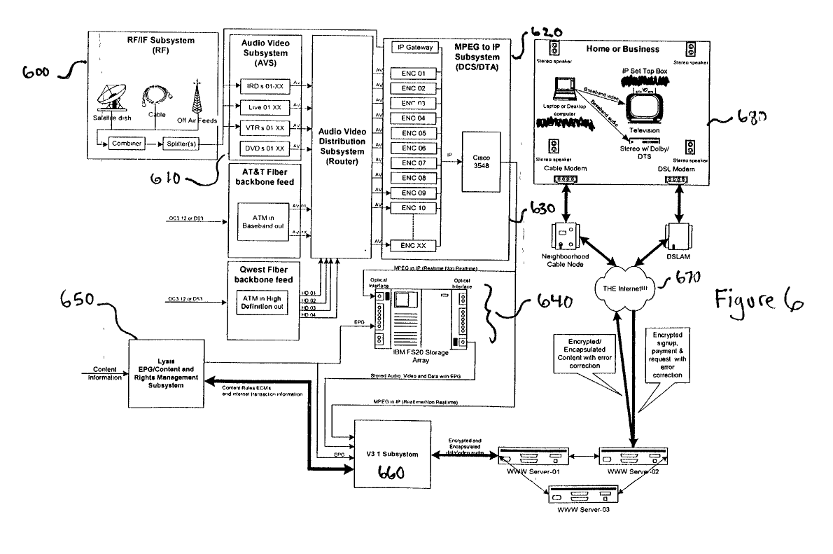

An architecture according to another embodiment of the present invention is shown in FIG. 6. It comprises seven major subsystems. An RF subsystem (RF) 600, an audio/video subsystem (AVS) 610, a baseband to MPEG to IP subsystem (DCS) 620, an MPEG to IP subsystem (DTA) 630, an IP storage and playout subsystem (VOD) 640, a content management subsystem 650 (e.g., Lysis) and a secure delivery subsystem (V31) 660.

In one embodiment, RF 600 receives analog and digital feeds from existing cable systems (e.g., SMPTE 259M), analog and digital satellite feeds, and analog off air feeds. In one embodiment, live feeds via an AT&T backbone and a satellite are used for realtime video. AVS 610 consists of audio and video outputs of IRDs used to accept live and non-live (pre-recorded) feeds from content providers. These feeds can come in either from the RF subsystem 600 or via the AT&T fiber backbone feed. All of the feeds can consist of live events (concerts, sporting events, distance learning, enterprise training, news events, etc.) or non-live feeds such as major content provider feeds in the form of movies, sporting events, concerts etc. The AVS 610 subsystem also receives feeds from High Definition TV suppliers.

DCS subsystem 620 comprises a number of MPEG encoders. These encoders are capable of encoding material in MPEG1, MPEG2, and MPEG4. They receive both realtime and non-real-time feeds. The DCS 620 supports DolbyAC-3, THX, Dolby 5.1 & 6.1 and DTS audio encoding formats, for instance.

DTA subsystem 630 comprises a media gateway, such as a Minerva Media Gateway or equivalent DVB (ASI) to IP converter. The DTA subsystem 630 takes pre-digitized (MPEG) content and turns it into a digital format and sends it out without effecting it in any way. The DTA system 630 is able to receive a signal with multiple programs per transport stream (MPTS) or a single program per transport stream (SPTS). In the case of MPTS, using PID filtering can drop unwanted programs.

VOD subsystem 640 comprises a storage array with very high throughput for video and audio playout and storage. The content on the VOD subsystem 640 is video (and audio) on demand. This can be in the form of movies, time sensitive AV material, distance learning material, sports events etc. All forms of digital data can also be stored in the VOD subsystem 640 for playout at a later time. This has use in the medical field for CAT scans and MRI feeds.

Content management subsystem 650 comprises one or more computers which catalogue incoming content, apply access rights to all content, track all transactions recorded by the V31 subsystem 660, issue financial and billing information for all transactions, control all subsystems relating to playout, control and billing, and format and transmit an electronic program guide (EPG).

Content management subsystem 650 is also used to control the authentication of the users when they log-on. For instance, in one embodiment, the user logs in to a computer that is configured to accept smart cards. In this scenario, content management subsystem 650 is used, at least in part, to ensure that the smart card was verified before the content is delivered. Likewise, the present invention may require the use of PIN numbers or biometric identifiers, such as voice imprints, thumb prints, or retinal scans, before the content is delivered.

V31 subsystem 660 comprises one or more computers. The V31 subsystem 660 accepts the feed from the DCS 620 or DTA 630 subsystems and encapsulates packets having a header and a payload from MPEG in IP to a secure format. This content is then sent out to the subscriber for viewing. The V31 system 660 also accepts feeds from the VOD subsystem 640. This content is also MPEG in IP but in this case the EPG from content management subsystem 650 is included. The VOD content is then sent to the subscriber in the same way as the DCS 620 or DTA 630 content is.

In one embodiment, the V31 subsystem 660 accepts an EPG feed from the content management subsystem 650 and incorporates it with any content coming from the DCS 620 or DTA 630 subsystems. In another embodiment, the V31 subsystem 660 adds the two factors to the encapsulated packets it generates, which are triple DES with rolling encryption and error correction. By the time the content (what ever its origin) leaves the V31 subsystem 660 it is encoded completely secure for billing purposes, completely trackable for billing purposes, and viewable on any broadband connection on the Internet. The V31 subsystem is further described below.

V31 Subsystem

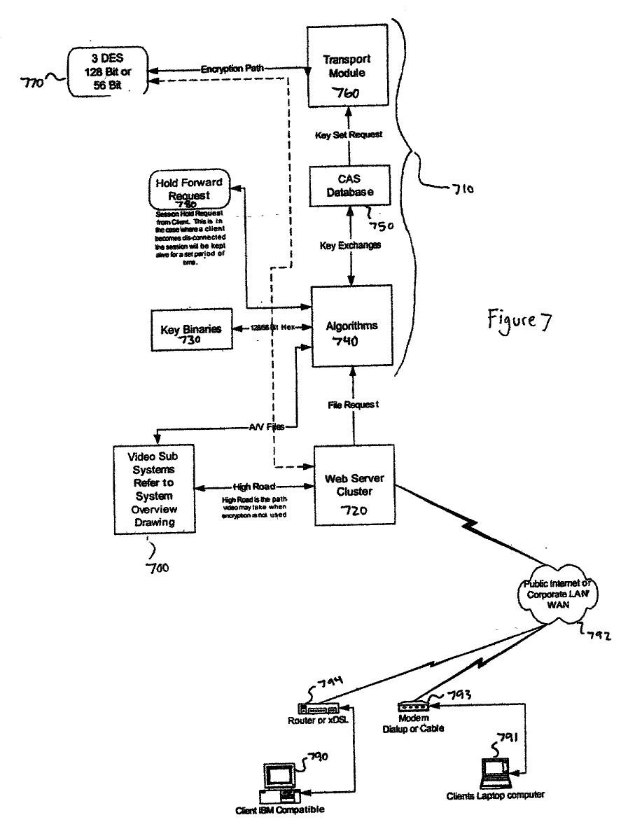

The V31 subsystem is used as a secure delivery mechanism by the present invention. It is used to encapsulate the digital media with the security data to ensure protection of the digital media from copying by unauthorized users. FIG. 7 shows a process that takes place, in part, in the V31 subsystem according to an embodiment of the present invention. Video subsystem block 700 is used to transport the digital media to be delivered to the user to the V31 subsystem 710 in raw form (i.e., unencrypted).

A high road maybe taken when encryption is not needed, in which case, the digital media is transported directly to web server cluster block 720 and eventually to clients 790 and 791. If secure delivery is used, key binary block 730 sends a key binary to algorithm block 740. For instance, key binary block 730 in one embodiment sends a 128 or a 56 bit hex based key that is set to roll from 1 to 16 at a setable interval, which disallows the hacking of the key binary and the root key exchange.

Algorithm block 740 receives the key from block 730 and applies an algorithm to the key. For instance in one embodiment, algorithm block 740 operates as follows:

1. The algorithm block receives the following Hex key 0000 1010 0011 1111;

2. At a predetermined interval it is rolled to 0001 1010 0011 1111;

3. At the next predetermined interval it is rolled to 0011 1010 0011 1111;

4. At the next predetermined interval it is rolled to 0111 1010 0011 1111;

5. The process repeats until all characters have been cycled through and the algorithm restarts at the beginning.

Algorithm block 740 may use other schemes to roll the encryption key as well. Once the algorithm block 740 performs its function, a key exchange is made to a database 750 where client access control and permissions are stored for future log-ons and use by the client. A key set request is made from the database 750 to a transport module 760. A hardware based key accelerator is used to generate the keys in one embodiment.

Then, in transport module 760, a unique client identifier, such as a MAC address, is associated with a key pair that is then encoded with the DES sequence and applied to the key binary, which generates the rolling code sequence. This sequence is encapsulated in transport block 760 wherein it forms packets having the sequence embedded in the packet. In one embodiment, the packet has a header where the sequence is applied to succeeding packets and encapsulated into the header. The packets also contain a payload having the digital media that is being delivered for use. At this point, the digital media is encrypted and scrambled and the key for decryption maybe scrambled as well.

The packets are sent via an encryption path to 3DES block 770 and then to one or more clients 790 and 791, for instance, by traveling through web server cluster 720 to the public Internet or corporate LAN/WAN block 792 and through communication devices 793 and 794 where they are decrypted, unscrambled, and used. Thereafter, an exchange occurs between the clients 790 and 791 and the V31 subsystem 710 using the embedded key exchange mechanism. Standards based 3DES is used in one embodiment because it is an internationally recognized encryption standard that uses 128 or 56 bit packets.

Algorithm block 740 may also use hold forward request block 780 if a session hold request is made from the client. This is in the case where the client becomes disconnected. This block allows the session to remain alive for a set period of time.

IP Multi-Casting

In one embodiment, the server uses an IP multi-cast to support sessions with multiple clients. Multi-casting refers to sending a packet from an input port to multiple output ports. Multicasting is used for various reasons. One reason to multicast is when a user wishes to tune into a live event, such as a movie in progress. In this scenario, there may be multiple clients watching the movie via a computer network When one client desires to tune in, the video is broken down into one or more cells. The cells are sent from the input port (server), where the movie is playing, to all of the output ports, where all of the other members' computing devices are connected. The cells travel across a fabric, which might be the Internet or other communication medium.

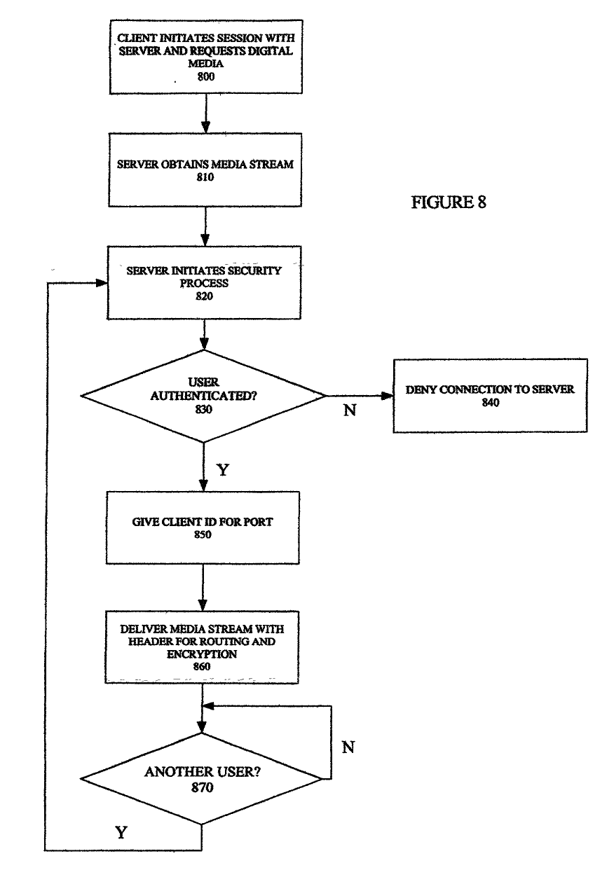

Multicasting involves inserting a header into each cell. The header contains a mask that indicates what output ports to send the message to. For instance, if there are 64 output ports that a cell may be broadcast to, then each cell would have a 64 bit mask that indicates to the fabric which of the 64 output ports are to receive the multi-casted cell. In one embodiment, IP-multicasting is supported in the secure delivery of digital media. This embodiment is shown in FIG. 8.

At box 800, a client computing device initiates a session with a server and requests a digital media stream. At box 810, the server obtains the media stream, for instance by accessing a database where the media stream is stored. At box 820, the server initiates a security process. At box 830, it is determined if the user was authenticated using the security process. If not, the connection is denied at box 840. Otherwise, the client receives an id for its port at box 850 and at box 860, the server delivers the media stream along with a header that is used to route the stream to the client and to encrypt the data. At box 870, it is determined if another user wishes to receive the same media stream via a multi-cast. If not, box 870 repeats. Otherwise, the process repeats at box 820.

Variable Length Encryption Keys

Depending on the destination for the digital media, different lengths of encryption keys are used in the DES standards. Locations outside of the United States largely use 56 bit encryption standard while locations within the United States largely use a 128 bit encryption standard. By examining the destination IP address and the number of hops between routers in the path for the digital media, it can be determined where the media is going. Once this is known, the rolling keys to be used in the encryption process and encapsulated into the packets can be varied. Take, for instance, the case of a multi-cast that takes place in different locations around the world. In this case different locations may receive different length keys.

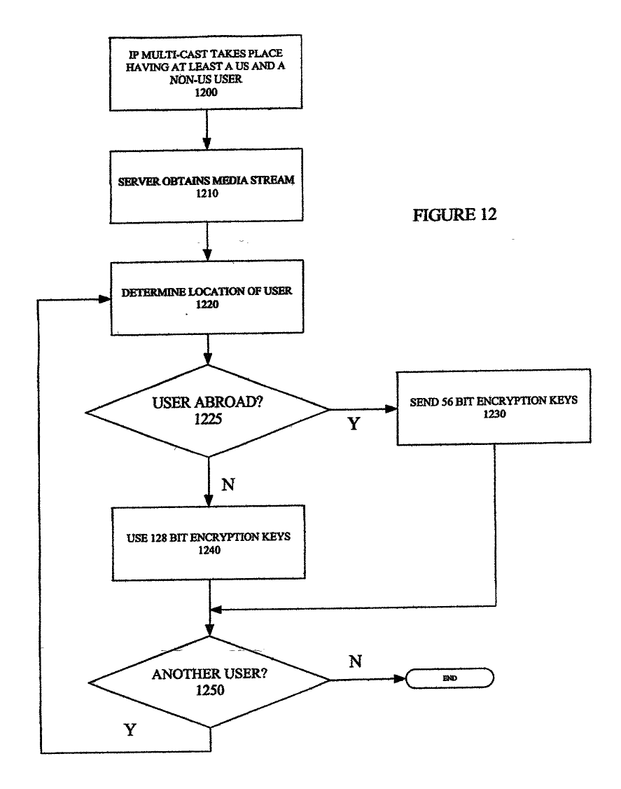

This process is shown in FIG. 12. At box 1200, an IP multi-cast takes place, wherein at least a domestic and an international user request the multicast and are authenticated. At box 1210, the digital media is obtained. At box 1220, the location of a user is determined, for instance by examining their IP address and the number of hops from the media source. At box 1225, it is determined if the user is abroad (i.e., non-US). If the user is abroad, a 56 bit DES standard is encapsulated into the packets at box 1230 and they are sent. Otherwise, a 128 bit DES is encapsulated and it is sent at box 1240. At box 1250, after box 1240 or 1230, it is determined if there is another user. If not, the process ends. Otherwise, the process repeats at box 1220.

Dedicated Connection

In one embodiment, an analog file is converted to a digital file and stored on a server connected to the Internet. Then, the digital file is indexed and catalogued in a database with one or more other digital files. When a user accesses the Internet and uses the database to locate an appropriate digital file for downloading, software coupled to their web browser (a plug in) initiates the creation of a dedicated connection, for instance by authenticating to the server and exchanging keys. The dedicated connection in one embodiment is based on a unique address associated with the client device, such as an IP or MAC address.

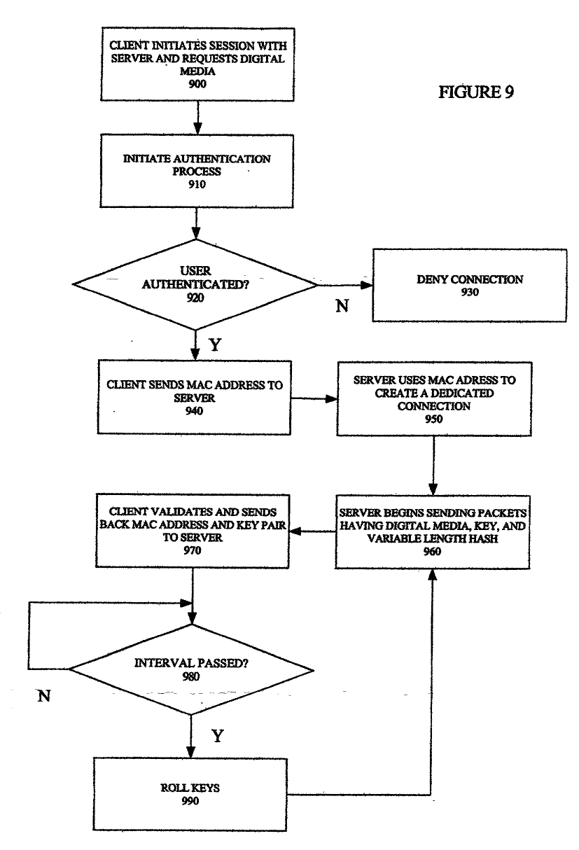

Once the dedicated connection is established, the server begins delivering the media. In one embodiment, the media is sent as a series of packets that are concatenated with encryption data that continually scrambles the data (i.e., rolling code encryption data). This embodiment of the present invention is shown in FIG. 9.

At box 900, a client computing device initiates a session with a server and requests a digital media stream. At box 910, the server initiates an authentication process. At box 920 it is determined if the user was authenticated. If not, the connection is denied at box 930. Otherwise, the client sends a MAC address to the server at box 940. At box 950 the MAC address is used to create a dedicated connection. At box 960, the server begins sending packets to the client having the digital media, a key, and a variable length hash. At box 970, the client validates the word and returns a MAC address and key pair to the server. At box 980, it is determined if an interval has passed (e.g., 45 miliseconds). If not, the process waits. If so, the keys are rolled at box 990 and box 960 repeats.

Packet Format

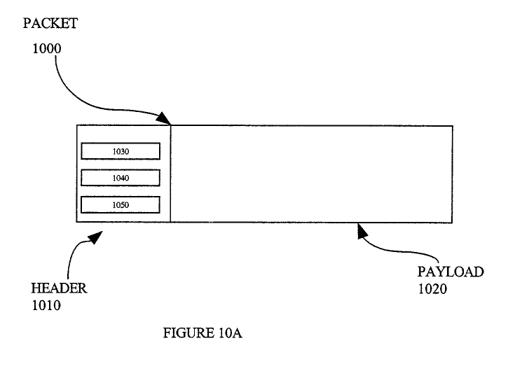

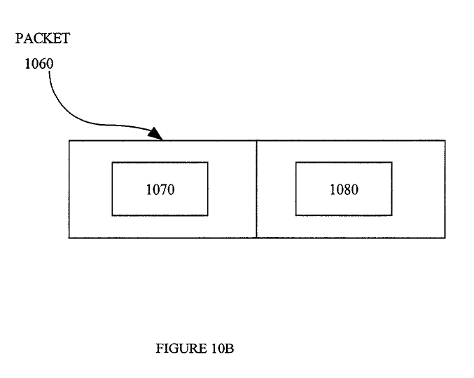

FIG. 10A shows how the digital data is organized in one embodiment. The digital data sent from the server to the client is in the form of a packet 1000, which is 4096 bits long. Packet 900 contains a header 1010 and a payload 1020. The header includes, a 128 bit word 1030, a variable length hash 1040, and a key 1050. The data sent from the client to the server is shown in FIG. 10B. Packet 1060 includes MAC address 1070, which is a unique identification for the client device and a key 1080. A key exchange occurs between the client and the server at predetermined intervals, for instance 45 milliseconds.

Embodiment of Computer Execution Environment (Hardware)

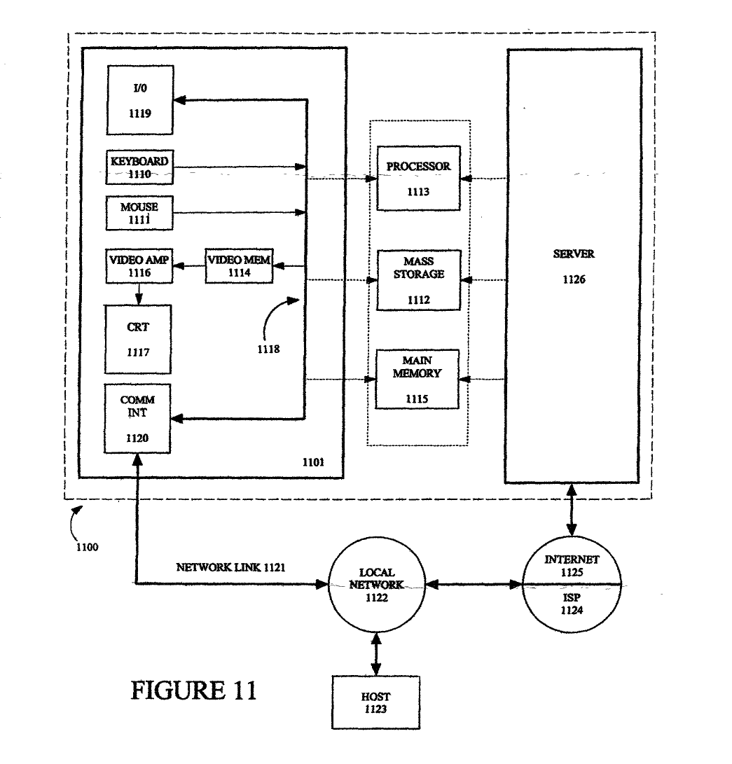

An embodiment of the invention can be implemented as computer software in the form of computer readable program code executed in a general purpose computing environment such as environment 1100 illustrated in FIG. 11, or in the form of byte code class files executable within a Java™ run time environment running in such an environment, or in the form of bytecodes running on a processor (or devices enabled to process bytecodes) existing in a distributed environment (e.g., one or more processors on a network). A keyboard 1110 and mouse 1111 are coupled to a system bus 1118. The keyboard and mouse are for introducing user input to the computer system and communicating that user input to central processing unit (CPU) 1113. Other suitable input devices may be used in addition to, or in place of, the mouse 1111 and keyboard 1110. I/O (input/output) unit 1119 coupled to bidirectional system bus 1118 represents such I/O elements as a printer, A/V (audio/video) I/O, etc.

Computer 1101 may include a communication interface 1120 coupled to bus 1118. Communication interface 1120 provides a two-way data communication coupling via a network link 1121 to a local network 1122. For example, if communication interface 1120 is an integrated services digital network (ISDN card or a modem, communication interface 1120 provides a data communication connection to the corresponding type of telephone line, which comprises part of network link 1121. If communication interface 1120 is a local area network (LAN card, communication interface 1120 provides a data communication connection via network link 1121 to a compatible LAN. Wireless links are also possible. In any such implementation, communication interface 1120 sends and receives electrical, electromagnetic or optical signals which carry digital data streams representing various types of information.

Network link 1121 typically provides data communication through one or more networks to other data devices. For example, network link 1121 may provide a connection through local network 1122 to local server computer 1123 or to data equipment operated by ISP 1124. ISP 1124 in turn provides data communication services through the world wide packet data communication network now commonly referred to as the “Internet” 1125. Local network 1122 and Internet 1125 both use electrical, electromagnetic or optical signals which carry digital data streams. The signals through the various networks and the signals on network link 1121 and through communication interface 1120, which carry the digital data to and from computer 1100, are exemplary forms of carrier waves transporting the information.

Processor 1113 may reside wholly on client computer 1101 or wholly on server 1126 or processor 1113 may have its computational power distributed between computer 1101 and server 1126. Server 1126 symbolically is represented in FIG. 11 as one unit, but server 1126 can also be distributed between multiple “tiers”. In one embodiment, server 1126 comprises a middle and back tier where application logic executes in the middle tier and persistent data is obtained in the back tier. In the case where processor 1113 resides wholly on server 1126, the results of the computations performed by processor 1113 are transmitted to computer 1101 via Internet 1125, Internet Service Provider (ISP) 1124, local network 1122 and communication interface 1120. In this way, computer 1101 is able to display the results of the computation to a user in the form of output.

Computer 1101 includes a video memory 1114, main memory 1115 and mass storage 1112, all coupled to bi-directional system bus 1118 along with keyboard 1110, mouse 1111 and processor 1113. As with processor 1113, in various computing environments, main memory 1115 and mass storage 1112, can reside wholly on server 1126 or computer 1101, or they maybe distributed between the two. Examples of systems where processor 1113, main memory 1115, and mass storage 1112 are distributed between computer 1101 and server 1126 include the thin-client computing architecture developed by Sun Microsystems, Inc., the palm pilot computing device and other personal data assistants, Internet ready cellular phones and other Internet computing devices, and in platform independent computing environments, such as those which utilize the Java technologies also developed by Sun Microsystems, Inc.

The mass storage 1112 may include both fixed and removable media, such as magnetic, optical or magnetic optical storage systems or any other available mass storage technology. Bus 1118 may contain, for example, thirty-two address lines for addressing video memory 1114 or main memory 1115. The system bus 1118 also includes, for example, a 32-bit data bus for transferring data between and among the components, such as processor 1113, main memory 1115, video memory 1114 and mass storage 1112. Alternatively, multiplex data/address lines may be used instead of separate data and address lines.

In one embodiment of the invention, the processor 1113 is a microprocessor manufactured by Motorola, such as the 680X0 processor or a microprocessor manufactured by Intel, such as the 80X86, or Pentium processor, or a SPARC microprocessor from Sun Microsystems, Inc. However, any other suitable microprocessor or microcomputer maybe utilized. Main memory 1115 is comprised of dynamic random access memory (DRAM). Video memory 1114 is a dual-ported video random access memory. One port of the video memory 1114 is coupled to video amplifier 1116. The video amplifier 1116 is used to drive the cathode ray tube (CRT) raster monitor 1117. Video amplifier 1116 is well known in the art and may be implemented by any suitable apparatus. This circuitry converts pixel data stored in video memory 1114 to a raster signal suitable for use by monitor 1117. Monitor 1117 is a type of monitor suitable for displaying graphic images.

Computer 1101 can send messages and receive data, including program code, through the network(s), network link 1121, and communication interface 1120. In the Internet example, remote server computer 1126 might transmit a requested code for an application program through Internet 1125, ISP 1124, local network 1122 and communication interface 1120. The received code maybe executed by processor 1113 as it is received, and/or stored in mass storage 1112, or other non-volatile storage for later execution. In this manner, computer 1100 may obtain application code in the form of a carrier wave. Alternatively, remote server computer 1126 may execute applications using processor 1113, and utilize mass storage 1112, and/or video memory 1115. The results of the execution at server 1126 are then transmitted through Internet 1125, ISP 1124, local network 1122 and communication interface 1120. In this example, computer 1101 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for the delivery of digital media using packetized encryption data is described in conjunction with one or more specific embodiments. The invention is defined by the claims and their full scope of equivalents.

1. A method for distributing a digital media comprising:
establishing a connection between a client and a server;
requesting said digital media with said client;
obtaining said digital media with said server;
delivering said digital media from said server to said client across a network connection, wherein said digital media comprises an encapsulated packet having a security item and at least a portion of said digital media.

2. The method of claim 1 wherein said packet further comprises:
a header and a payload, wherein said payload comprises said portion of said digital media and said header comprises said security item.

3. The method of claim 2 wherein said digital media data item is a video stream or an audio stream.

4. The method of claim 2 wherein said security item is a triple DES rolling code encryption key.

5. The method of claim 4 further comprising:
modifying said encryption key at a regular interval.

6. The method of claim 5 wherein said interval is a 45 millisecond interval.

7. The method of claim 5 wherein said step of modifying further comprises:
incrementing said encryption key by a single binary digit.

8. The method of claim 1 wherein said client comprises a general purpose computer.

9. The method of claim 1 wherein said client comprises a personal data assistant.

10. The method of claim 1 wherein said client comprises a set-top box.

11. The method of claim 1 wherein said client comprises a web-enabled cellular phone.

12. The method of claim 2 wherein said packet is a 4096 bit packet and wherein said header is a 128 bit header.

13. The method of claim 1 wherein said step of obtaining further comprises:
accessing a second server having a database wherein said digital media resides in said database.

14. The method of claim 1 wherein said step of obtaining further comprises:
authenticating said client and denying access to said digital media if said client is not authenticated.

15. The method of claim 1 further comprising:
varying a length of said security item depending upon a geographic location of said client

16. A computer program product comprising:
a computer usable medium having computer readable program code embodied therein configured to distribute a digital media, said computer program product comprising:
computer readable code configured to cause a computer to establish a connection between a client and a server;
computer readable code configured to cause a computer to request said digital media with said client;
computer readable code configured to cause a computer to obtain said digital media with said server;
computer readable code configured to cause a computer to deliver said digital media from said server to said client across a network connection, wherein said digital media comprises an encapsulated packet having a security item and at least a portion of said digital media.

17. The computer program product of claim 16 wherein said packet further comprises:
a header and a payload, wherein said payload comprises said portion of said digital media and said header comprises said security item.

18. The computer program product of claim 16 wherein said digital media data item is a video stream or an audio stream.

19. The computer program product of claim 16 wherein said security item is a triple DES rolling code encryption key.

20. The computer program product of claim 19 further comprising:
computer readable code configured to cause a computer to modify said encryption key at a regular interval.

21. The computer program product of claim 20 wherein said interval is a 45 millisecond interval.

22. The computer program product of claim 20 wherein said computer readable code configured to cause a computer to modify further comprises:
computer readable code configured to cause a computer to increment said encryption key by a single binary digit.

23. The computer program product of claim 16 wherein said client comprises a general purpose computer.

24. The computer program product of claim 16 wherein said client comprises a personal data assistant.

25. The computer program product of claim 16 wherein said client comprises a set-top box.

26. The computer program product of claim 16 wherein said client comprises a web-enabled cellular phone.

27. The computer program product of claim 17 wherein said packet is a 4096 bit packet and wherein said header is a 128 bit header.

28. The computer program product of claim 16 wherein said computer readable code configured to cause a computer to obtain further comprises:
computer readable code configured to cause a computer to access a second server having a database wherein said digital media resides in said database.

29. The computer program product of claim 16 wherein said computer readable code configured to cause a computer to obtain further comprises:
computer readable code configured to cause a computer to authenticate said client and deny access to said digital media if said client is not authenticated.

30. The computer program product of claim 16 further comprising:
computer readable code configured to cause a computer to vary a length of said security item depending upon a geographic location of said client

31. An digital media delivery apparatus comprising:
a client and a server configured to have a connection established;
a digital media configured to be requested with said client;
a storage medium configured to be used to obtain said digital media with said server;
a network connection configured to be used to deliver said digital media from said server to said client, wherein said digital media comprises an encapsulated packet having a security item and a portion of said digital media.

32. The apparatus of claim 31 wherein said packet further comprises:
a header and a payload, wherein said payload comprises said portion of said digital media and said header comprises said security item.

33. The apparatus of claim 31 wherein said digital media data item is a video stream or an audio stream.

34. The apparatus of claim 31 wherein said security item is a triple DES rolling code encryption key.

35. The apparatus of claim 34 further comprising:
a modified encryption key configured to be generated by modifying said encryption key at a regular interval.

36. The apparatus of claim 35 wherein said interval is a 45 millisecond interval.

37. The apparatus of claim 35 wherein said step of modified encryption key is configured to be generated by incrementing said encryption key by a single binary digit.

38. The apparatus of claim 31 wherein said client comprises a general purpose computer.

39. The apparatus of claim 31 wherein said client comprises a personal data assistant.

40. The apparatus of claim 31 wherein said client comprises a set-top box.

41. The apparatus of claim 31 wherein said client comprises a web-enabled cellular phone.

42. The apparatus of claim 31 wherein said packet is a 4096 bit packet and wherein said header is a 128 bit header.

43. The apparatus of claim 31 wherein said storage medium further comprises:
a second server coupled to a database configured to be accessed by said server wherein said digital media resides in said database.

44. The apparatus of claim 31 further comprising:
an authentication mechanism configured to authenticate said client and deny access to said digital media if said client is not authenticated.

45. The apparatus of claim 31 further comprising:
a length of said security item configured to be varied depending upon a geographic location of said client
